(19) United States
(12) Patent Application Publication
(10) Pub. No.: US 2008/0299524 A1
(43) Pub. Date: Dec. 4, 2008

(54) Method and System for Employee Training and Reward

(76) Inventor: Mark Murrell, Newmarket (CA)

Correspondence Address: BERESKIN AND PARR, 40 KING STREET WEST, BOX 401, TORONTO, ON, M5H 3Y2, CA

(21) Appl. No.: 12/129,121

(22) Filed: May 29, 2008

Related U.S. Application Data
(60) Provisional application No. 60/941,421, filed on Jun. 1, 2007.

(51) Int. Cl. G09B 7/00; G09B 5/12

(52) U.S. Cl. 434/219; 434/350

(57) ABSTRACT

A method for receiving training where the method comprises participating in one or more training exercises conducted on a computing station; receiving reward points for the completion of one or more training exercises; and redeeming the reward points for one or more rewards offered by a rewards provider.

### CROSS-REFERENCE TO RELATED APPLICATIONS

This application claims the benefit of U.S. Provisional Patent Application No. 60/941,421 filed Jun. 1, 2007 for an invention entitled “Method and System for Employee Training and Reward”, the entire contents of which is hereby incorporated by reference.

### FIELD

The embodiments described herein relate generally to a system and method for training, and more specifically to methods and systems for automated training of users where various incentives are provided.

### BACKGROUND

It has become increasingly more important to ensure that employees receive training in order to perform their job, and to improve their performance. Training is often an integral part of employee development programs, where employers aim to provide training in various forms to their employees.

One form of training involves the use of in-class training methods. These methods involve a teacher instructing one or more students through live interaction. Other methods of training involve engaging in self-directed exercises, where trainees are asked to review material themselves. Such self-directed exercises involve reading relevant material that has been assigned to them, and/or engaging in computer-based training exercises.

Computer-based training exercises often require employees to engage in the training exercise on their own time. Even when the employer requires the employee to undertake the training, it is often difficult for many employees to be motivated to engage in such exercises on their own time. This is particularly true for those that do not work in a typical office setting, and who perform shift work. The various training tools that have been developed do not provide for effective ways to motivate employees to undertake training, even when mandatory.

### SUMMARY

The embodiments described herein, provide in one aspect a computer implemented method for receiving training. The method comprises participating in one or more training exercises conducted on a computing station; receiving a score for the completion of one or more of the training exercises; receiving reward points based on the score received for completion for the completion of one or more training exercises; and redeeming the reward points for one or more rewards offered by a rewards provider.

The embodiments described herein, provide in another aspect a computer-implemented method for providing training to one or more users. The method comprises providing one or more training exercises to one or more users for completion on a computing station; evaluating the one or more users performance on the one or more training exercises; assigning a score to each of the one or more users based on the evaluation of their performance; converting the score into a reward point measure for each of the one or more users, wherein the reward points may be redeemed by the one or more users for one or more rewards offered by one or more rewards providers.

The embodiments described herein, provide in another aspect a computer implemented method for providing training to one or more users. The method comprises providing one or more training exercises to one or more users for completion on a computing station; evaluating the one or more users performance on the one or more training exercises; assigning a score to each of the one or more users based on the evaluation of their performance; converting the score into a reward point measure for each of the one or more users; submitting information regarding the number of reward points to one or more reward providers; and receiving information from one or more reward providers regarding one or more rewards that may be available based on the number of reward points.

### BRIEF DESCRIPTION OF THE DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram illustrating the components of a training system;

FIG. 2 is a block diagram illustrating the components of a computing station and a training station;

FIG. 3 is a block diagram illustrating the components of a training server in an exemplary embodiment;

FIG. 4 is a sample of a registration screen;

FIG. 5 is a block diagram illustrating the fields of a user database;

FIG. 6 is a block diagram illustrating the fields of a training database;

FIG. 7 is a block diagram illustrating the fields of a points database;

FIG. 8 is a flowchart illustrating the steps of a training method;

FIG. 9 is a flowchart illustrating the steps of a recognition method;

FIG. 10 is a flowchart illustrating the steps of a rewards redemption method; and

FIG. 11 is a sample of a user introduction screen.

### DETAILED DESCRIPTION

It will be appreciated that for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, or cellular telephone. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The inventive system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

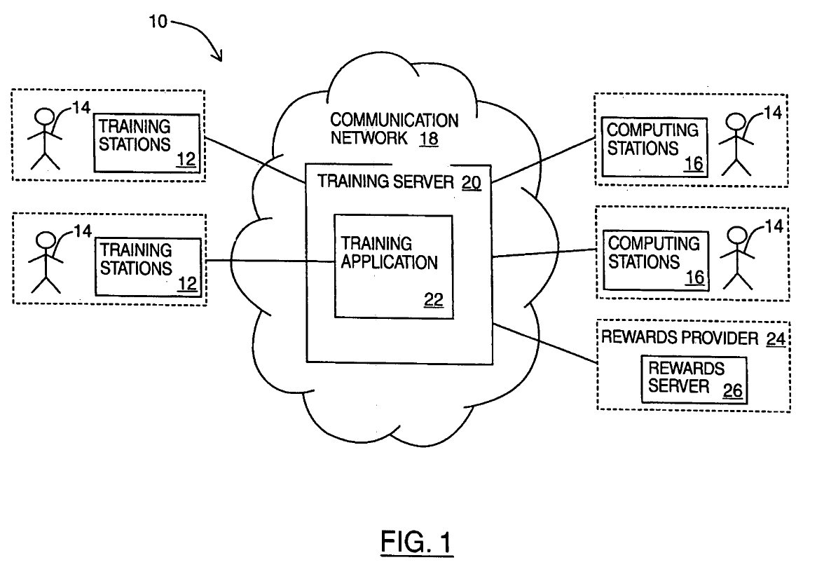

Reference is now made to FIG. 1, where a diagram illustrating the components of a training and reward system 10 is shown in an exemplary embodiment. The training and reward system 10 is used to train individuals with respect to certain tasks and to provide them with, and test them on the content of relevant materials. In an exemplary embodiment, the system 10 is described with respect to the training of employees. For purposes of this description, the users of the system 10 are described as employees, though as will be understood by one of skill in the art, the users are not restricted to being employees, and may be any individuals that require some form of training. Through use of the system 10, the employees undertake one or more training exercises that are part of a course or program. Each course or program have associated with them, one or more training exercises. A training exercise tests the employee's knowledge and educates the employee 14. As any type of training exercises may be developed, the system 10 may be employed by any industry that requires training for their respective employees. In an exemplary embodiment, the training system 10 is comprised of training stations 12 that are engaged by employees. The training stations 12 are dedicated computing devices that in an exemplary embodiment, are located at an employee's workplace. The training stations 12 allow employees to access the system 10 and to participate in their respective training exercises while at their workplace. Computing stations 16 may also be used by employees to participate in training exercises. The training stations 12 and computing stations 16 communicate with a training server 20 through a communication network 18. The communication network 18 may be any network that allows for network communication between computing devices. The training server 20, has a training application 22 associated with it, which in an exemplary embodiment is a software application that is used to design and conduct the respective training exercises. The training application 22 is described in further detail below. Upon completion of any training exercise, the respective employee is provided with some form of reward and/or recognition as described below, which are collectively referred to as incentives. The incentives provided to the employee serve to motivate the employee to complete the training exercises. Based on the type of incentive that is being offered, the training server 20 may communicate with a rewards provider 24, and more specifically with a rewards server 26. The rewards provider 24, in an exemplary embodiment, is a third party that administers a rewards program that allows those who have accumulated certain levels of reward points to collect rewards. The reward points are accumulated through the completion of, and performance on those respective training exercises. The rewards server 26 is used to administer the third party rewards program. The training system 10 in an exemplary embodiment, may provide rewards that are offered by the administrator of the system 10, or from one or more multiple third party rewards providers 24, or from any combination of the two.

The training stations 12, in an exemplary embodiment are dedicated computing stations that are used to administer the training exercises. Such training stations 12 may be located in settings where the employees may not have ready access to computing stations 16. The computing stations 16 are computing devices that have network capabilities, and may include, but are not limited to, laptop computers, slim line computers, desktop computers, server type computers, hand held computers, and other computing devices that allow for network connectivity, user input, and a display.

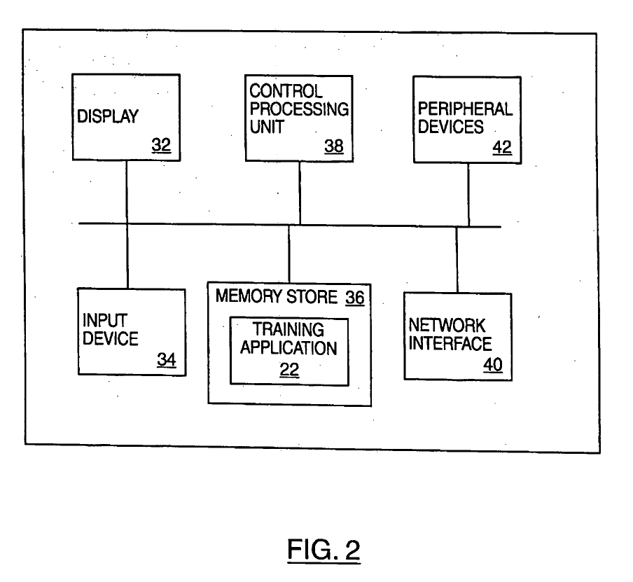

Reference is now made to FIG. 2, where the components associated with a training station 12 and a computing station 16 in an exemplary embodiment are illustrated in further detail. In an exemplary embodiment, the training station 12, and computing station 16 have associated with them a display 32, an input device 34, a memory store 36, a central processing unit 38, a network interface 40, and one or more optional peripheral devices 42. The display 32 is a monitor type device that is used to display information. The input devices 34 may be any device that allows for input, examples of which may include, but are not limited to, keyboards and pointing devices. The memory store 36 is a permanent storage associated with the device. In one embodiment, the memory store 36 may have stored upon it the training application 22. However, in an exemplary embodiment the system 10 is accessed through the Internet. The central processing unit 38 is used to execute instructions for operation of the device 12. The network interfaces 40 may be wired or wireless network interfaces that allow the device to connect to a communication network. The peripheral devices 42 may include but are not limited to, devices such as printers, and scanners.

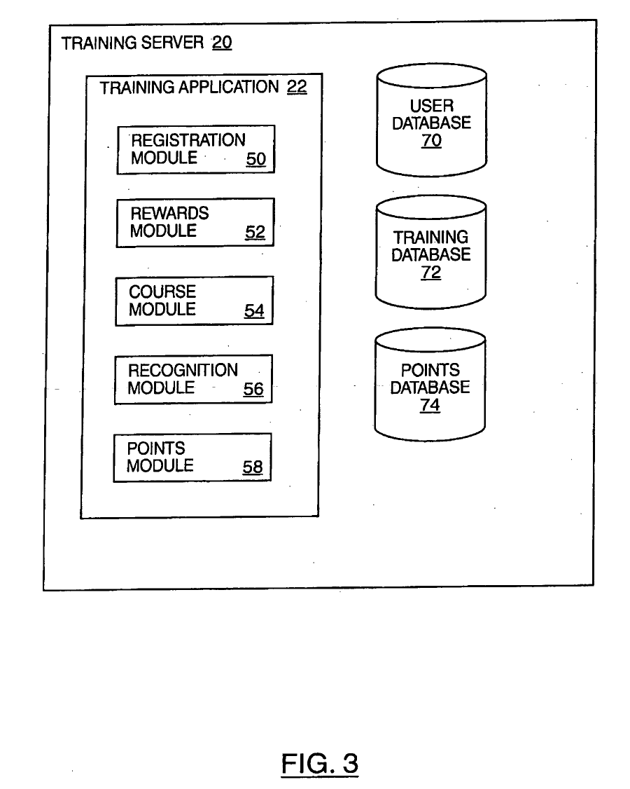

Reference is now made to FIG. 3, where the components of the training server 20 are illustrated in further detail in an exemplary embodiment. The training server 20, in an exemplary embodiment has associated with it a training application 22. In an exemplary embodiment, the training application 22 is a software application that allows an administrator to create, modify and administer training courses or programs that are comprised of one or more training exercises. The training exercises may be designed such that they are institutional, or industry specific. An institution may be any entity whose members take part in the training exercises, and may include, but are not limited to schools, corporations, associations, and government. Industry specific exercises are designed for all members that are associated with a specific occupation or subclass of an occupation.

The training application 22, in an exemplary embodiment, is a software application that comprises a registration module 50, a reward module 52, a course module 54, a recognition module 56, and a points module 58. The registration module 50 allows an employee to register with the system 10, to access the system 10, and to participate in the respective training exercises. The reward module 52 is used to assign rewards to users based on the completion of certain training exercises and to keep track of the redemption of any rewards. The course module 54 is used to design and administer courses and training exercises. The recognition module 56 is used to track the performance of a user with respect to the performance of other users. The points module 58, in an exemplary embodiment is used to assign points to users based on their performance.

The training server 20, in an exemplary embodiment also has resident upon it, one or more data storages that are used for the storage of data associated with the training system 10. In an exemplary embodiment, the training server has associated with it a user database 70, a training database 72, and a points database 74. The user database 70 stores information related to the users of the training system 10. The training database 72 stores information related to any exercises that have been undertaken by any users of the system 10. The course database 74 stores information regarding the training courses and exercises that are offered by the system 10. The points database 74 is used to store the reward identifiers, and points that have been awarded to each user. The respective databases are described in detail below, with respect to exemplary embodiments.

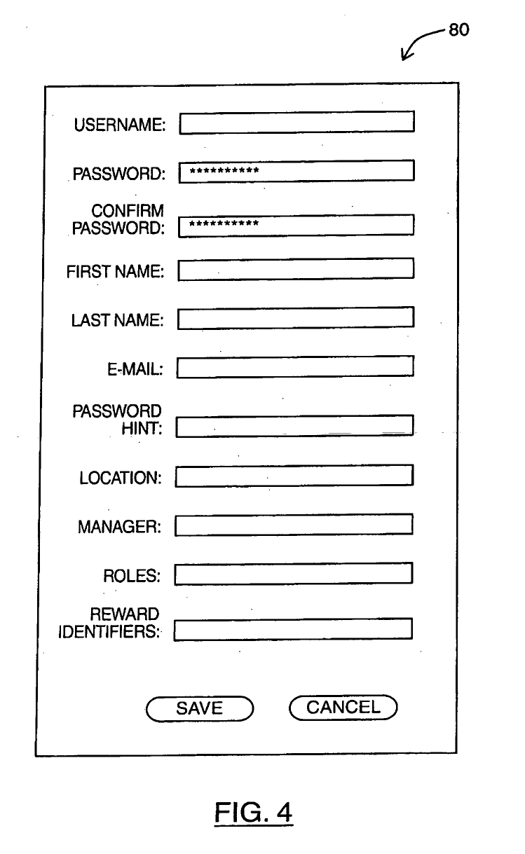

Reference is now made to FIG. 4, where in an exemplary embodiment, a sample registration screen 80 is shown. The sample registration screen 80 is used by the employee to register with the system 10. In an exemplary embodiment, as shown in FIG. 4, the user is asked to provide a user name, a password, a first and last name, an email address, and a description of their position, role or title. The user, in an exemplary embodiment also provides information regarding a rewards identifier. The rewards identifier, in an exemplary embodiment will depend on the reward partners that are associated with the system 10. Where there is more than one rewards partner associated with the system 10, the user may enter more than one rewards identifier. Each rewards identifier may be associated with a rewards partner. For example, for airlines that offer rewards such as points, the user when signing up may enter their respective rewards identifier associated with such a rewards program.

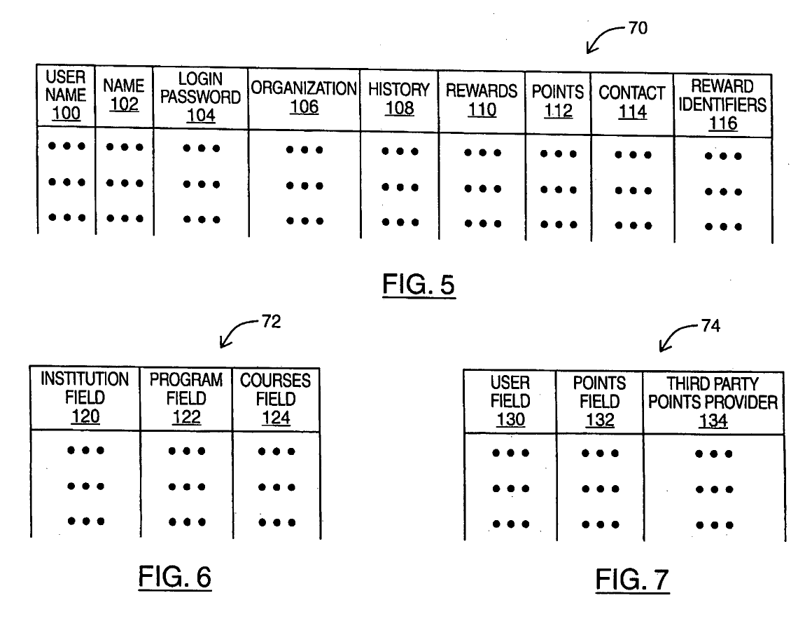

Reference is now made to FIG. 5, where the fields of the user database are shown in an exemplary embodiment. The user database 70, in an exemplary embodiment, comprises the following fields, a user name field 100, a name field 102, a login field 104, an organization field 106, a history field 108, a score field 110, a points field 112, a contact field 114, and a rewards identifier field 116. Each user of the system 10 has a record in the database. The user name field 100 stores the user name used to access the system 10. The name field 102 stores the first and last name of the user. The login field 104 stores the login name of the user along with the user's password. The organization field 106 stores the name of the organization, if any, that the user is associated with. The history field 108 stores information regarding the use of the system, and regarding any points that were earned by the user through completion of the respective training exercises. The rewards field 110 stores information regarding the rewards that were earned by the user. The points field 112 stores the number of points that are currently associated with each user. In an exemplary embodiment, the history rewards and points field may comprise sub tabs within the fields. The contact field 114 stores the contact information that is associated with each user. The rewards identifier field 116 stores the identifiers associated with the user's participation in third party reward programs.

Reference is now made to FIG. 6, where the fields of the training database 72 are illustrated in an exemplary embodiment. The training database 72, in an exemplary embodiment, has associated with it an institution field 120, a courses field 122 and a training exercises field 124. The institution field 120 stores the name of the institution, the courses field 122 stores the courses that are offered by the institution, and the training exercises field stores for each course the respective training exercises that are associated with the course.

Reference is now made to FIG. 7, where the fields of the points database are described in further detail with respect to an exemplary embodiment. The points database 74 stores for all users their current measure of points that they have been earned through use of the system 10. The fields of the database 74 in an exemplary embodiment comprise a user field 130, a points field 132, and a list of third party points providers 134.

The system 10 may be administered by an administrator of the system 10. Each course, and each training exercise has an administrator associated with it who may create, and modify the content of the respective exercises.

The courses are comprised of one or more training exercises. The training exercises in an exemplary embodiment, test the user and provide the user with a score based on their performance.

The administrator of the system 10, in an exemplary embodiment has various options that are provided to the administrator. The administrator of the system 10 may be responsible for the creation and maintenance of training exercises, or this task may be delegated by the administrator of the system 10. The administrator of the system in an exemplary embodiment, is able to register an individual or group of individuals (i.e., may register a group of individuals at one time).

The users of the system 10, as described in further detail below, have various options available to them with regards to use of the system 10. The users of the system 10 may use the system where the system 10 may operate in one or more modes. In an exemplary embodiment, the modes include a standard mode, a rewards mode, and a recognition mode. For each training exercise the system 10 may operate in any of one or more of the respective modes described below. The operation of the respective modes is described in further detail below. When a user is undertaking a training exercise in the standard mode, the user engages with one or more training exercises, and the completion of the respective training exercises is acknowledged by the system 10. In the standard mode of operation, in an exemplary embodiment, the acknowledgment of completion is a certificate or other similar form of notice. In the reward mode, where the respective training exercise is associated with a rewards program, reward points may be awarded based on the score achieved when a training exercise is completed, or where a training exercise is computed by a certain data. In the recognition mode, upon the completion of the respective training exercise a determination is made as to whether the user's performance is to be recognized. The system 10, and more specifically the respective courses and training exercises that are offered may be conducted in one of the three modes, or a combination of any of the three modes.

The administrator in an exemplary embodiment, is also able to administer the offerings from third party rewards providers. The third party rewards providers may specify advertising and other promotions that should be displayed to the users of the system 10. The advertising and other promotional information may be targeted based on various criteria, including but not limited to demographic information (including, but not limited to age, geography, sex) and job information. In an exemplary embodiment, the administrator may regulate which users the information is shown to, as some companies may not want to have their employees view any promotional offers when engaging in training.

When the training exercise or respective course is conducted in the reward mode, the user receives a notification informing them of the reward points they have earned based on their performance. For each training exercise the user completes, the user's performance is measured by a score. Based on the score that has been achieved, certain levels of reward points are awarded to the user. The level of reward points, in an exemplary embodiment, are determined by the administrator of the system 10. A notification is provided to the user upon completion of their respective training exercise, and in an exemplary embodiment is also provided to them through an electronic mail message. Notifications may also be provided to the user when their point totals have reached levels considered to be milestone levels. At milestone levels, the user is able to redeem points that have been awarded for certain rewards. For each third party rewards provider that is associated with the system 10, an exchange system is in place, where the user may redeem reward points earned through use of the system 10 for reward points from third party providers. The exchange system will also inform users regarding which third party rewards they are eligible for based on their current point total. Users of the system 10 depending on the third party rewards provider may also be able to purchase “points” from the third party providers. In an alternative embodiment, a user of the system 10 may engage in an auction, where the user submits their respective points to multiple third party rewards providers and they provide a reward that they would be willing to exchange for the reward points. This process may continue for as many iterations as required.

When the training exercise or respective course is offered in the recognition mode, the system 10 tracks the progress of other users who have completed the same training exercises. The recognition mode will determine the user's ranking in reference to all of the other users who have completed the respective training exercises. The respective determination may be made based on all other users who are associated with the same institution or industry.

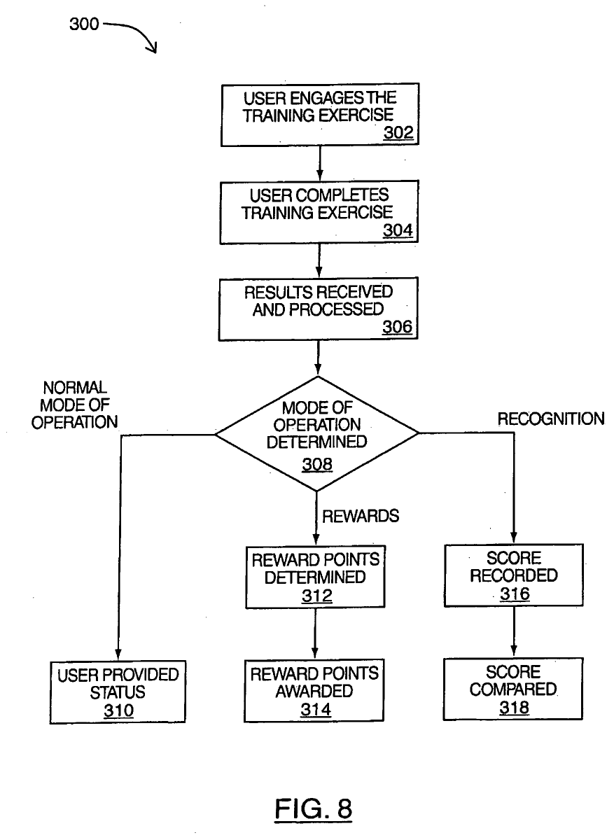

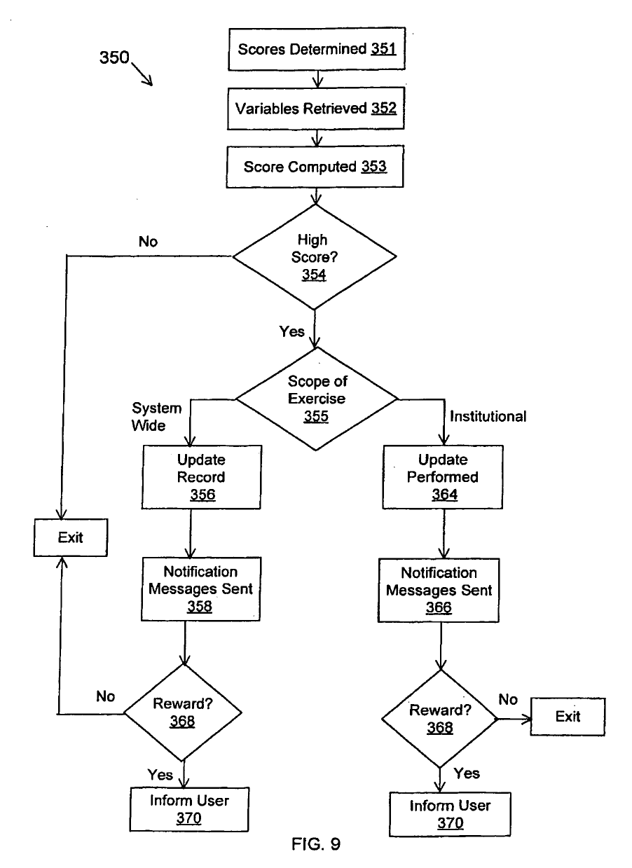

Reference is now made to FIG. 8, where the steps of a training method 300 are shown in an exemplary embodiment. The training method 300 illustrates the steps that are undertaken by the user when they engage one or more training exercises. Method 300 begins at step 302 where the user selects a training exercise they wish to undertake. As explained above, the training exercise has associated it with a course, and therefore the user may select the next training exercise in a series of training exercises associated with a course, or may be provided with only one or more specific training exercises to complete by the administrator. The user first accesses the respective training station or computing station, and authenticates themselves as registered users. At step 302, the user engages the respective training exercise, and completes the training exercise at step 304 based on the various components of the training exercise that have been shown to them. Method 300 then proceeds to step 306, where the results are received and processed by the training server. Where the results of the training exercise are received, method 300 proceeds to step 308, where a determination is made as to the mode of operation of the respective course and/or training exercise. If it is determined at step 308, that the training exercise is part of the normal mode of operation, method 300 proceeds to step 310. At step 310, the user's score that was received in the training exercise is recorded, so that the user's progress may be tracked. If at step 308, it is determined that the training exercise is a rewards based course, then method 300 proceeds to step 312. At step 312, the number of reward points to be awarded to the user are determined based upon the user's performance in the training exercise. Upon determining the number of points that are to be awarded, method 300 proceeds to step 314, where the number of points are awarded to the user. The respective databases are updated to reflect the number of points that have been awarded, and the user is notified regarding their point total. If at step 308, it is determined that the course or training exercise is associated with a recognition program, method 300 proceeds to step 316. At step 316, the score that is awarded upon the completion of the respective training exercise is recorded in the respective databases. Method 300 then proceeds to step 318, where a comparison between the score that was obtained and scores obtained by other users are undertaken. The processing steps that are undertaken at step 316 are explained in further detail below with respect to method 350 as shown in FIG. 9.

Reference is now made to FIG. 9, where the steps of a recognition method 350 are shown in an exemplary embodiment. In an exemplary embodiment, recognition method 350 is undertaken where the training exercise has been completed and the training exercise or course operates in a recognition mode. Method 350 begins at step 351, where the scores of the users are determined. The scores of other users who have conducted the same training exercises are checked and a determination is made regarding the rank of the user with regards to their score. Method 350 then proceeds to step 352 where information associated with the user is retrieved. Such information may include but is not limited to the length of time the user spent in the training exercise, the number of attempts the user made at conducting the exercise and other variables. Based on the score received by the user, and the variables retrieved at step 352, method 350 proceeds to step 353 where a performance measure is calculated for the user. The performance measure is used to rank the user in relation to the other users who have completed the training exercises. Method 350 then proceeds to step 354, where a determination is made regarding the user's performance. Specifically, the rank of the user is determined. If it is determined at step 354 that the user's performance is the highest ranked performance, a check is performed at step 355 to determine the scope of comparison for the training exercise the user engaged in. If it is determined at step 353 that the score does not represent a highest ranked performance, method 350 then terminates.

If at step 355, it is determined that the scope of the training exercise was industry wide 10, then method 350 proceeds to step 356. At step 356, an update is performed of the respective databases indicating that a system wide high score has been achieved. Method 350 then proceeds to step 358. At step 358, notification messages are transmitted to appropriate parties. A notification message may be transmitted by the system 10 to any individual that the system 10 has contact information for. In an exemplary embodiment, the notification message may be transmitted via email. The various individuals that receive notification may be set by the administrator and may include the supervisors of the employee. Method 350 then proceeds to step 360. At step 360, a check is performed to determine whether the user receives a reward for receiving the highest score. The determination as to whether a user receives a reward is made by the administrator when creating that particular course. If it is determined that the user receives a reward, method 350 proceeds to step 362 where the user informed.

If it is determined at step 354, that the scope of the training exercise is institutional, then method 350 proceeds to step 364. At step 364, an update is performed on the relevant records in the respective databases. Method 350 then proceeds to step 366, where all appropriate parties are notified that a new highest score for a respective exercise or course has been achieved. Method 350 then proceeds to step 368, where a check is performed to determine whether a reward is offered to the user based on their performance. If it is determined that a reward should be offered, method 350 proceeds to step 370 where the user is informed.

It should be noted that the modes of operation that have been described above, may all be associated with the same training exercise or course. For example, for any training exercise or course that is completed, the user may be provided both recognition and rewards and acknowledgement for their completion of the respective training exercise.

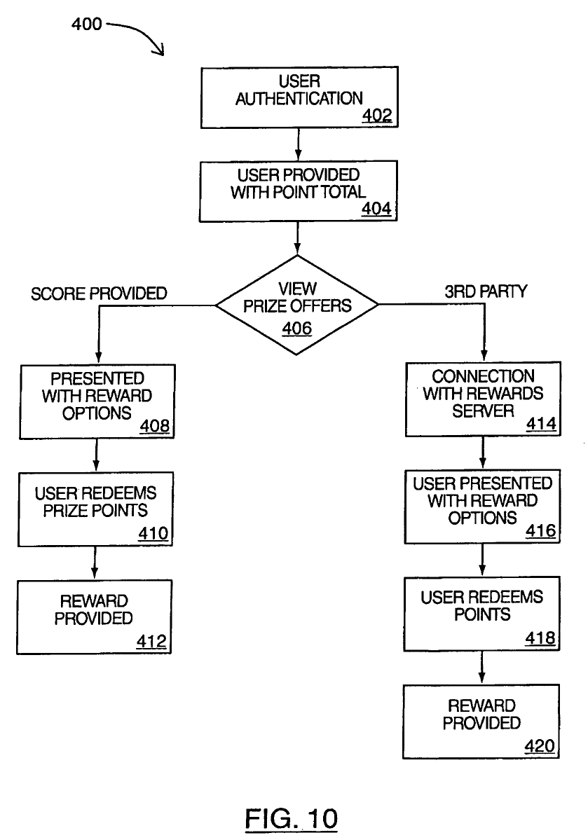

Reference is now made to FIG. 10, where the steps of a rewards redemption method 400 are shown, in an exemplary embodiment. In an exemplary embodiment, the reward redemption method 400 is used to redeem the reward points that have been awarded for a user's performance. The reward redemption method 400 begins at step 402, where a user authenticates him/herself. The user in an exemplary embodiment, accesses the rewards redemption method through a web site that is accessible from any computing station 16. In an exemplary embodiment, the redemption method 400 may also be accessed from a dedicated training station 12. Method 400 then proceeds to step 404, where the user is provided with their point total. Method 400 then proceeds to step 406, where the user is presented with the option of viewing rewards that are offered through an administrator of the system 10 or through third party reward providers. If at step 406, the user chooses to see the prizes that are offered by the service provider, method 400 then proceeds to step 408. At step 408, the user is presented with the various rewards that they may attempt to redeem their points for. At step 410, the user may chose to redeem their points for one or more of the offered rewards depending on the points they have accumulated. Method 400 then proceeds to step 412, where the reward is provided.

If at step 406, the user chooses to redeem their points with a third party rewards provider, method 400 then proceeds to step 414. At step 414, a connection is established with a remote third party rewards service provider. The third party rewards provider then provides the user the inventory of prizes that may be selected from at step 416. The determination as to the inventory of prizes that may be selected from is made based on the exchange system. Method 400 then proceeds to step 418, where the user chooses to redeem their reward points for one of the prizes that have been offered. Method 400 then proceeds to step 420, where the rewards are provided.

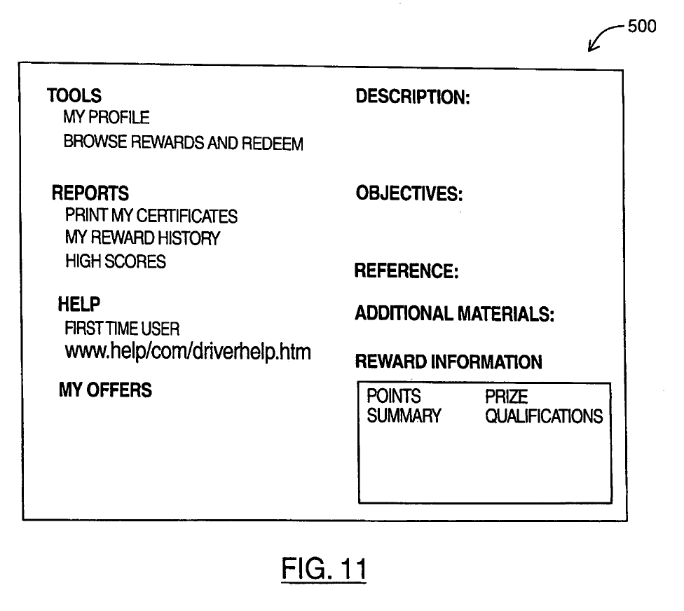

Reference is now made to FIG. 11, where a sample course information window 500 is shown in an exemplary embodiment. The course information window 500 provides the user information regarding a course that the user may participate in through the training system 10. The information window 500 provides the user information regarding the course, including the description, and objectives of the course. Furthermore, the user is provided with information regarding references for the course, and any other additional material that may be required of them to complete the course. The window 500 also displays to the user their current point total, and how many points that may be earned through successful completion of the respective course and/or the exercises that comprise the course. Points may be awarded as described above based on a user's performance with respect to an exercise, or may be awarded based on the act of completion of a respective exercise, or a combination of both. The information window 500 provides the user options regarding viewing detailed information from their profile, or allows them to redeem rewards, or allows them to request help. Furthermore, the user is able to select from various offers that are directed to them. Offers may be targeted to respective users based on their demographic and training information.

As discussed above, the administrator is able to create a course, and the respective training exercises that are associated with a course. The administrator may create courses, and can specify the content of the course, the scoring and reward scheme, specify bonuses, place date/restrictions, and specify the targeted audience for the course or exercises. Similarly, for any course or training exercise that has been created by the administrator the administrator may modify or edit the contents of the course and/or training exercise.

The present invention has been described with regard to preferred embodiments. However, it will be obvious to persons skilled in the art that a number of variants and modifications can be made without departing from the scope of the invention as described herein.

1. A computer implemented method for receiving training, the method comprising:
a) participating in one or more training exercises conducted on a computing station;
b) receiving a score for the completion of one or more of the training exercises;
c) receiving reward points based on the score received for completion for the completion of one or more training exercises; and
d) redeeming the reward points for one or more rewards offered by a rewards provider.

2. The method of claim 1, wherein the one or more training exercises include a training course.

3. The method of claim 1, wherein the one or more training exercises are specific to an industry.

4. The method of claim 1, wherein the one or more training exercises are specific to an institution.

5. A computer implemented method for providing training to one or more users, the method comprising:
a) providing one or more training exercises to one or more users for completion on a computing station;
b) evaluating the one or more users performance on the one or more training exercises;
c) assigning a score to each of the one or more users based on the evaluation of the user's performance;
d) converting each user's score into a reward point measure for the user, wherein the reward points may be redeemed by the user for one or more rewards offered by one or more rewards providers.

6. The method of claim 5, wherein the one or more training exercises include a course.

7. The method of claim 5, wherein the one or more training exercises are specific to an industry.

8. The method of claim 5, wherein the one or more training exercises includes an advertising component that is displayed to the one or more users.

9. The method of claim 8, wherein the advertising component is targeted to the one or more users based on employment information associated with the one or more users.

10. The method of claim 9, wherein the advertising component is targeted to the one or more users based on demographic information associated with the one or more users.

11. The method of claim 5, wherein a notification message is sent to the each of the one or more users when their reward points have reached one or more predetermined levels.

12. A computer implemented method for providing training to one or more users, the method comprising:
a) providing one or more training exercises to one or more users for completion on a computing station;
b) evaluating the one or more users performance on the one or more training exercises;
c) assigning a score to each of the one or more users based on the evaluation of the user's performance;
d) converting each user's score into a reward point measure for the user;
e) submitting information regarding the number of reward points to one or more reward providers; and
f) receiving information from one or more reward providers regarding one or more rewards that may be available based on the number of reward points.

13. The method of claim 12, wherein the one or more training exercises include a course.

14. The method of claim 12, wherein the one or more training exercises are specific to an industry.

15. The method of claim 12, wherein the one or more training exercises includes an advertising component that is displayed to the one or more users.

16. The method of claim 15, wherein the advertising component is targeted to the one or more users based on employment information associated with the one or more users.

17. The method of claim 15, wherein the advertising component is targeted to the one or more users based on demographic information associated with the one or more users.

18. The method of claim 12, wherein a notification message is sent to each of the one or more users when their reward points have reached one or more predetermined levels.
